(19) United States
(12) Patent Application Publication
(10) Pub. No.: US 2008/0123515 A1
(43) Pub. Date: May 29, 2008

(54) Orthogonal frequency multiplexing

(76) Inventors: Kenneth A. Boehlke, Portland, OR (US); Seth M. Pinsky, Hillsboro, OR (US)

Correspondence Address: SMITH-HILL AND BEDELL, P.C., 16100 NW CORNELL ROAD, SUITE 220, BEAVERTON, OR, 97006, US

(21) Appl. No.: 11/455,135

(22) Filed: Jun. 16, 2006

(51) Int. Cl. H04J 11/00

(52) U.S. Cl. 370/206; 370/203

(57) ABSTRACT

An OFDM transmitter includes a lookup table for storing at least two groups of data digits associated with different respective characteristic frequencies (e.g. 3960 MHz, 5016 MHz). An addressing circuit addresses the lookup table and repeatedly and sequentially selects the groups of data digits. The data digits of the selected group are output sequentially. The output sequence of data digits is converted to analog form, and each group of data digits, when output and converted to analog form, provides a carrier signal at the characteristic frequency associated with that group. The carrier signal is modulated in accordance with an information signal to provide a transmission signal.

### BACKGROUND OF THE INVENTION

This invention relates to orthogonal frequency multiplexing.

In several digital modulation techniques, a group of consecutive data bits in an input data stream Di is represented by a symbol. Different combinations of data bits are represented by different symbols. For example, in the case of the group being composed of three bits, there are eight possible combinations and accordingly there are eight different symbols. One common type of digital modulation employing eight symbols is 8-level phase shift keying (8-PSK), in which the eight different symbols induce eight equiangularly spaced values of phase displacement in the bandpass representation.

Orthogonal frequency division multiplexing (OFDM) is a digital modulation technique in which an input data stream is decomposed into several subsidiary streams, each subsidiary stream is represented by a sequence of symbols, and the several sequences of symbols (up to several thousand sequences) are used to modulate respective carriers of constant frequency. The modulated carriers are summed to produce a transmission signal, which is supplied to a transmitter antenna for transmission to a receiver antenna. Receivers equal in number to the carriers and tuned to the carriers respectively receive and detect the sequences of symbols. Each sequence of symbols is then used to recover the corresponding subsidiary data stream, and the subsidiary data streams are combined in order to recreate the original data stream, which may be an HDTV signal. The carriers are sufficiently spaced in frequency and are phased such that they are orthogonal, i.e. each receiver sees only its own carrier.

FIG. 1 illustrates in very simplified form a transmitter and receiver for use with multi-band OFDM, or MB-OFDM. Referring to FIG. 1, a timing generator 8 receives a clock signal CLK and generates a three bit output signal that repeatedly cycles through eight possible values. A local oscillator 10 decodes the output signal of the timing generator 8 and, in response to each of the eight possible values, generates a carrier at a selected one of eight possible frequencies f1-f8. Thus, the oscillator 10 has eight operating frequencies that are selected sequentially and cyclically based on the output of the counter. The oscillator steps from one frequency to the next in the sequence at intervals of 312.5 ns.

The transmitter also includes N (as many as 100) subcarrier channels 16, each of which includes a subcarrier oscillator 18 that generates a subcarrier at a selected constant frequency F. The different oscillators 18₁-18_{N} operate at different respective, mutually orthogonal, frequencies F1-FN. Each subcarrier channel 16 also includes a quadrature phase shift key (QPSK) modulator 20 which modulates the subcarrier in phase based on the value of a two bit data word D to provide a QPSK modulated output signal and thereby encodes the subcarrier with the data word D.

The output signals of the subcarrier channels 16 are summed and the resulting composite subcarrier signal is mixed with the output signal of the local oscillator 10 to produce a transmission signal, which is supplied to a transmitter antenna 22 for transmission to a receiver antenna 24. During a transmission interval in which the carrier frequency is equal to f3, for example, the transmission signal includes signal components at frequencies (f3+F1), (f3+F2), . . . (f3+FN). Thus, the transmission signal occupies a block of transmission frequencies from (f3+F1) to (f3+FN). The subcarrier frequencies F1-FN are chosen so that the eight blocks of transmission frequencies do not overlap and are sufficiently spaced to avoid interference.

A receiver that is connected to the receiver antenna 24 includes a receiver local oscillator 26 that is synchronized with the transmitter oscillator 10. The receiver LO signal is mixed with the receiver antenna signal and provides an output signal that contains frequency components at the N subcarrier frequencies respectively and is supplied to N receiver subcarrier channels 28, tuned to the subcarrier frequencies F1-FN respectively. Each receiver subcarrier channel includes a QPSK demodulator 30 that recovers the data words D that were encoded by the corresponding QPSK modulator 20.

Standards promulgated by the WiMedia Alliance define fourteen frequency bands of which the center frequencies are given by 2904+528×n (MHz) where n=1, . . . 14. The transmitter shown in FIG. 1 is implemented using the lower eight frequency bands.

The current WiMedia standard also specifies an adjacent channel power ratio (ACPR) of at least 20 db. Thus, when the carrier frequency is 3960 MHz, for example, the signal that is transmitted in any of the other frequency bands must have a power level at least 20 db lower than the power in the 3960 MHz band. In order to comply with this requirement, the local oscillator 10 must change frequency from a first frequency to a second frequency, e.g. from f3 to f4, in less than 10 ns.

U.S. patent application Ser. No. 10/778,699, the entire disclosure of which is hereby incorporated by reference herein for all purposes, discloses an orthogonal frequency multiplexing scheme that differs from the conventional MB-OFDM scheme by employing a carrier that changes monotonically in frequency during a ramp interval and is modulated in phase in accordance with an information signal.

FIG. 2 illustrates schematically a practical implementation of the orthogonal frequency multiplexing scheme described in U.S. patent application Ser. No. 10/778,699. In an implementation of the transmitter described in U.S. patent application Ser. No. 10/778,699, a lookup table contains, at each of several locations, an array of digital values that represent samples of a waveform at a given frequency and modulated in phase in accordance with a given symbol. The number of locations in the lookup table is such that the table stores, for each frequency, samples representing the waveform modulated in accordance with each of the eight possible values of phase displacement. By appropriately addressing the lookup table, reading out the contents of the addressed locations of the LUT, and converting the digital values to analog form, a carrier that varies cyclically in frequency and is modulated in phase is generated.

In the case of FIG. 2, the timing generator 56 generates a sample conversion clock signal having a frequency Fclk of 3.2 GHz and also generates pulses for clocking the data bits into a register 50 and a five-bit signal that is incremented at intervals of 10 ns. FIG. 2 illustrates a symbol mapping table 54 that is addressable by an address of the form (channel, data). The channel portion of the address is provided by the timing generator 56 whereas the data portion is provided by the group of three consecutive data bits in the input data stream Din. At each addressable location, the table 54 stores a word Idigital and a word Qdigital. The words Idigital, Qdigital stored at the location (channel_m, data_k) are each read out in bit-parallel form at the start of channel interval m in response to data bits that map to the symbol k and are converted to respective sequences of two-bit words by serializers 58I and 58Q. Each serializer outputs the appropriate sequence of two-bit words at uniform intervals during the channel interval m. The sequences of digital words are applied to respective DACs 62 that convert the digital words to analog form under control of the sample conversion clock signal. Each two-bit word has one of three legal values. Depending on its value, each two-bit word received by a DAC is converted to a positive voltage pulse (+1), a negative voltage pulse (−1), or no pulse at all (0). The conversion times of the DAC 62Q are delayed by half a clock cycle relative to the DAC 62I and accordingly the output pulse sequences of the two DACs are mutually offset in time. Since the conversion times of the two DACs are interleaved, the quadrature DACs have an effective combined sample conversion rate of 6.4 GHz. The two mutually offset pulse sequences Ianalog and Qanalog are combined by an output summer and applied to a transmitter antenna 64, which also serves as a reconstruction filter and transmits the appropriate modulated carrier signal.

At the receiver, the timing generator 66 is synchronized with the transmitter timing generator 56 and addresses a table 68 that outputs a pair of words Ic and Qc for each time slot. The words Ic and Qc correspond to the words stored in the table 54 except that they do not include a term that is dependent on k. As in the case of the transmitter, these bit parallel words are converted to sequences of two-bit words by serializers and the two-bit words are converted by quadrature DACs to sequences of pulses. The two sequences of pulses are reconstructed and the resulting sinusoidal analog signals are mixed with the receiver antenna signal and generate signals Uanalog and Vanalog that are converted to digital form and supplied to a DSP engine 70 that implements a timing recovery function and a demodulation and demapping function. The DSP engine demodulates the signals Udigital and Vdigital and recovers the values I, Q and demaps the symbol and outputs the corresponding data bits Dout, which match the data bits Din. The DSP engine also supplies control signals to the timing generator 66 to preserve synchronism with the transmitter timing generator 56.

It would be advantageous if a radio transmitter could be operated selectively in either the conventional MB-OFDM mode described with reference to FIG. 1 or the FM-OFDM mode described with reference to FIG. 2. However, the different respective modes of operation have hitherto limited the extent to which components may be shared by the two transmitters.

### SUMMARY OF THE INVENTION

In accordance with a first aspect of the invention there is provided an OFDM transmitter comprising a lookup means (LUT plus serializers) for storing at least two groups of data digits associated with different respective characteristic frequencies (e.g. 3960 MHz, 5016 MHz), an addressing means (bank select plus timing gen) for addressing the lookup means and repeatedly and sequentially selecting the two groups of data digits, the lookup means being responsive to the addressing means by outputting sequentially the data digits of the selected group, a converter means (DACs plus quadrature modulator) for converting a sequence of data digits output by the lookup means to analog form, each group of data digits, when output and converted to analog form, providing a carrier signal at the characteristic frequency associated with that group, and a modulator means (modulator 108) for modulating the carrier signal in accordance with an information signal to provide a transmission signal.

In accordance with a second aspect of the invention there is provided an OFDM transmitter comprising a lookup means (LUT plus serializers) having a first page for storing at least two groups of data digits associated with different respective characteristic frequencies (e.g. 3960 MHz, 5016 MHz) and a second page for storing additional groups of data digits representing respective symbols each characterized by at least one of phase and frequency, an addressing means (bank select plus timing generator) for addressing the lookup means, the addressing means being operable in a first mode in which the addressing means addresses the first page of the lookup means by repeatedly and sequentially selecting the groups of data digits of the first page, the lookup means being responsive to the addressing means in the first mode by outputting sequentially the data digits of the selected group, and the addressing means being operable in a second mode in which the addressing means addresses the second page of the lookup means in accordance with a group of digital data digits for selecting a symbol, the lookup means being responsive to the addressing means in the second mode by outputting sequentially the data digits representing the selected symbol, a converter means (DACs plus quadrature modulator 92I) for converting a sequence of data digits output by the lookup means to analog form, an output means (modulator 108 plus multiplexer 130) having a first state in which the output means receives an output signal of the converter means and modulates said output signal in accordance with an information signal to provide an output signal of the transmitter and having a second state in which the output means provides an output signal of the converter means as an output signal of the transmitter, and wherein in the event that the addressing means operates in the first mode and the output means is in the first state, the output means provides a transmission signal that is modulated in accordance with said information signal, and in the event that the addressing means operates in the second mode and the output means is in the second state, the output means provides a transmission signal representing said selected symbol.

In accordance with a third aspect of the invention there is provided an OFDM receiver for receiving a carrier signal modulated in accordance with an information signal, the receiver comprising a lookup means (LUT plus serializers) for storing at least two groups of data digits associated with different respective characteristic frequencies (e.g. 3960 MHz, 5016 MHz), an addressing means (bank select plus timing gen) for addressing the lookup means and repeatedly and sequentially selecting the two groups of data digits, the lookup means being responsive to the addressing means by outputting sequentially the data digits of the selected group, a converter means (DACs plus quadrature modulator) for converting a sequence of data digits output by the lookup means to analog form, each group of data digits, when output and converted to analog form, providing a frequency conversion signal at the characteristic frequency associated with that group, and a modulator means (demodulator 108) for modulating the carrier signal in accordance with the frequency conversion signal to provide a baseband information signal for demodulation.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic block diagram illustrating the principle of operation of the multi-band OFDM transmitter and receiver,

FIG. 2 illustrates schematically the manner of operation of an FM-OFDM modulation scheme,

FIGS. 3A and 3B respectively illustrate schematically a first wireless radio transmitter and a first wireless radio receiver embodying the present invention,

FIGS. 4A and 4B illustrate respective waveforms that are useful in explaining operation of the transmitter shown in FIG. 3, and

FIG. 5 illustrates schematically a second wireless radio transmitter embodying the present invention.

### DETAILED DESCRIPTION

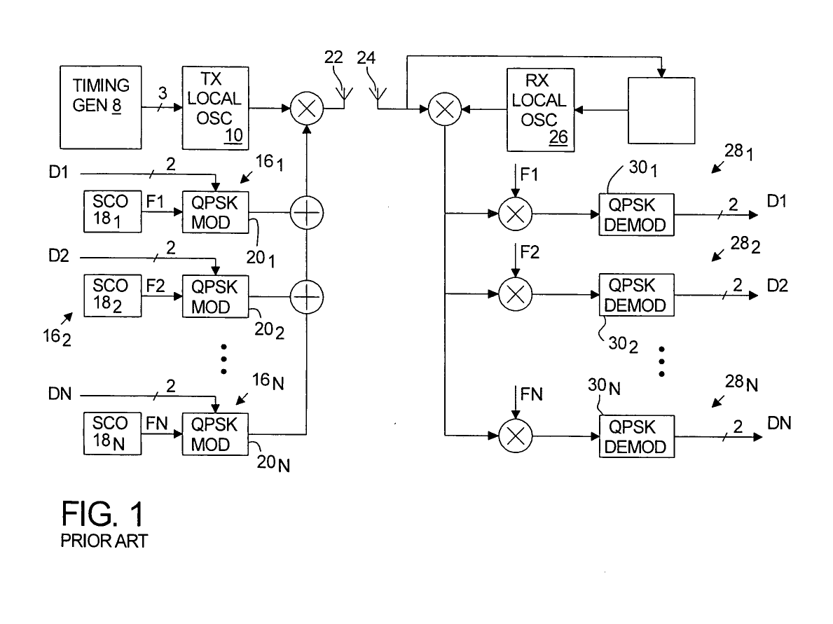

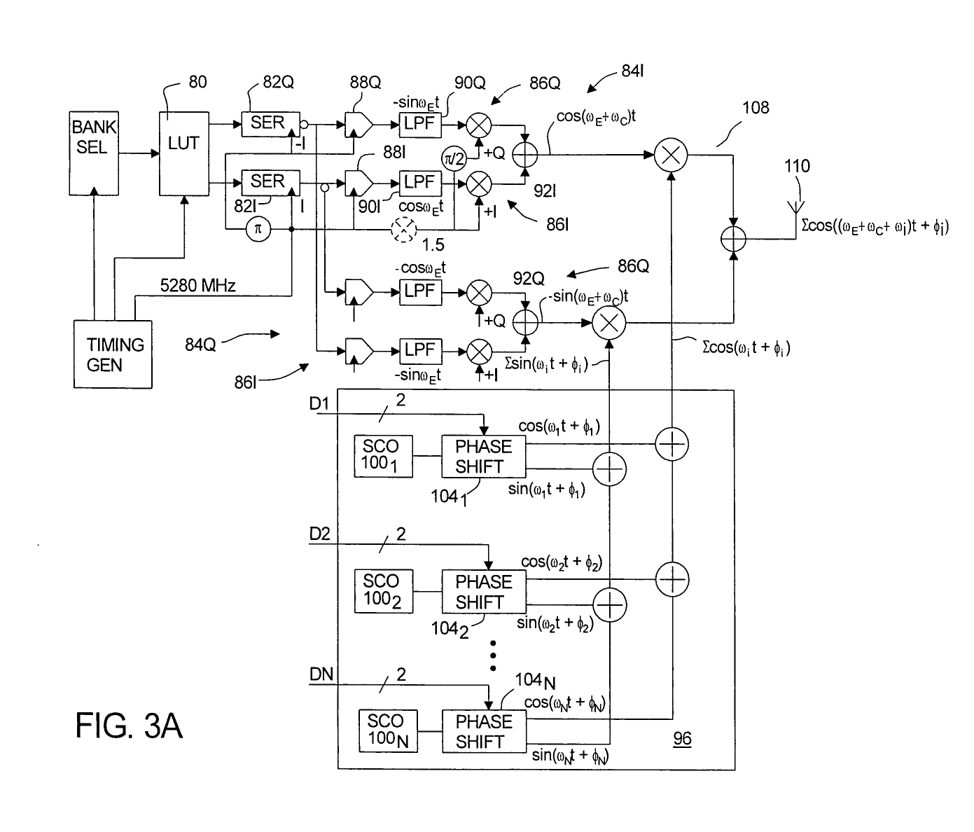

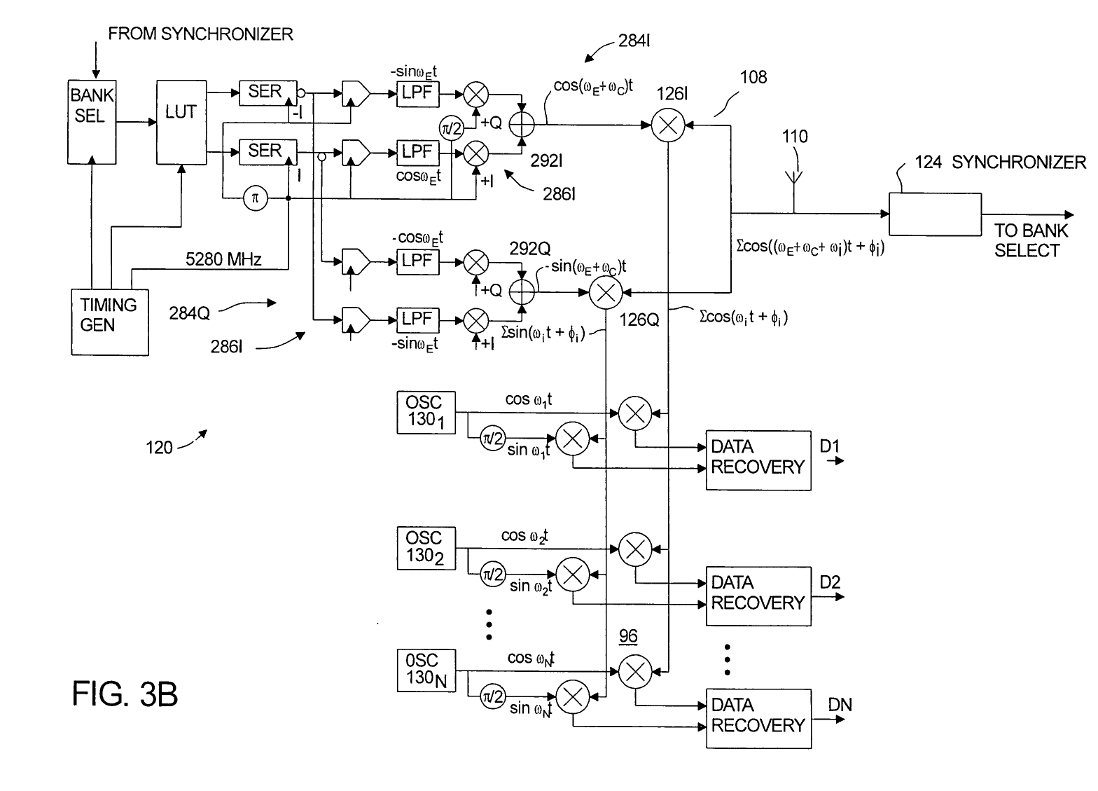

FIG. 3A illustrates schematically a multi-band OFDM transmitter employing a frequency-hopping local carrier synthesizer operating under control of a master in-phase clock signal I at a frequency of 5280 MHz. The carrier synthesizer serves the purpose of the local oscillator 10 in the MB-OFDM transmitter shown in FIG. 1. The carrier synthesizer includes a lookup table (LUT) 80 having eight banks, each of which stores two sets RE, IM of 60 2-bit words. The eight banks are selected by a 3-bit bank select signal in a cyclically repeating sequence, each being selected for an interval of 312.5 ns. At intervals of 1/88 μs, the two sets of 60 2-bit words stored in the selected bank are read from the LUT and are supplied to respective serializers 82I, 82Q. The serializer 82I outputs the 2-bit words in response to the 5280 MHz clock signal I whereas the serializer 82Q outputs the 2-bit words in response to the inverted clock signal −I. The outputs of the serializers are supplied to an in-phase channel 84I and a quadrature channel 84Q, each of which includes an in-phase arm 86I and a quadrature arm 86Q.

Considering the in-phase channel 84I, the in-phase arm 86I includes a 2-bit DAC 88I which converts the 2-bit words received from the serializer 82I to an analog output voltage under control of the in-phase clock signal I The DAC 88I is programmed to convert the 2-bit words to voltages proportional to the DAC full-scale output voltage V_{fs} in accordance with Table 1:

TABLE 1

| Input | Output * 3 |
|---|---|
| 0 0 | −1 |
| 0 1 | −3 |
| 1 0 | +3 |
| 1 1 | +1 |

### The range of the voltage V_{fs} is represented by ±3 in order to avoid the need to use fractional notation.

Since each 2-bit input word is mapped uniquely to a quaternary value, it will be convenient to use the corresponding quaternary values when referring to the contents of the LUT.

Table 2 shows the pairs of quaternary values corresponding to the two sets of 2-bit words stored in one bank of the LUT.

TABLE 2

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| RE | 3 | 1 | −3 | −1 | 3 | 1 | −3 | −1 | 3 | 1 | −3 | −1 | 3 | 1 | −3 |
| IM | −1 | −3 | 1 | 3 | −1 | −3 | 1 | 3 | −1 | −3 | 1 | 3 | −1 | −3 | 1 |
| | 15 | 16 | 17 | 18 | 19 | 20 | 21 | 22 | 23 | 24 | 25 | 26 | 27 | 28 | 29 |
| RE | −1 | 3 | 1 | −3 | −1 | 3 | 1 | −3 | −1 | 3 | 1 | −3 | −1 | 3 | 1 |
| IM | 3 | −1 | −3 | 1 | 3 | −1 | −3 | 1 | 3 | −1 | −3 | 1 | 3 | −1 | −3 |
| | 30 | 31 | 32 | 33 | 34 | 35 | 36 | 37 | 38 | 39 | 40 | 41 | 42 | 43 | 44 |
| RE | −3 | −1 | 3 | 1 | −3 | −1 | 3 | 1 | −3 | −1 | 3 | 1 | −3 | −1 | 3 |
| IM | 1 | 3 | −1 | −3 | 1 | 3 | −1 | −3 | 1 | 3 | −1 | −3 | 1 | 3 | −1 |
| | 45 | 46 | 47 | 48 | 49 | 50 | 51 | 52 | 53 | 54 | 55 | 56 | 57 | 58 | 59 |
| RE | 1 | −3 | −1 | 3 | 1 | −3 | −1 | 3 | 1 | −3 | −1 | 3 | 1 | −3 | −1 |
| IM | −3 | 1 | 3 | −1 | −3 | 1 | 3 | −1 | −3 | 1 | 3 | −1 | −3 | 1 | 3 |

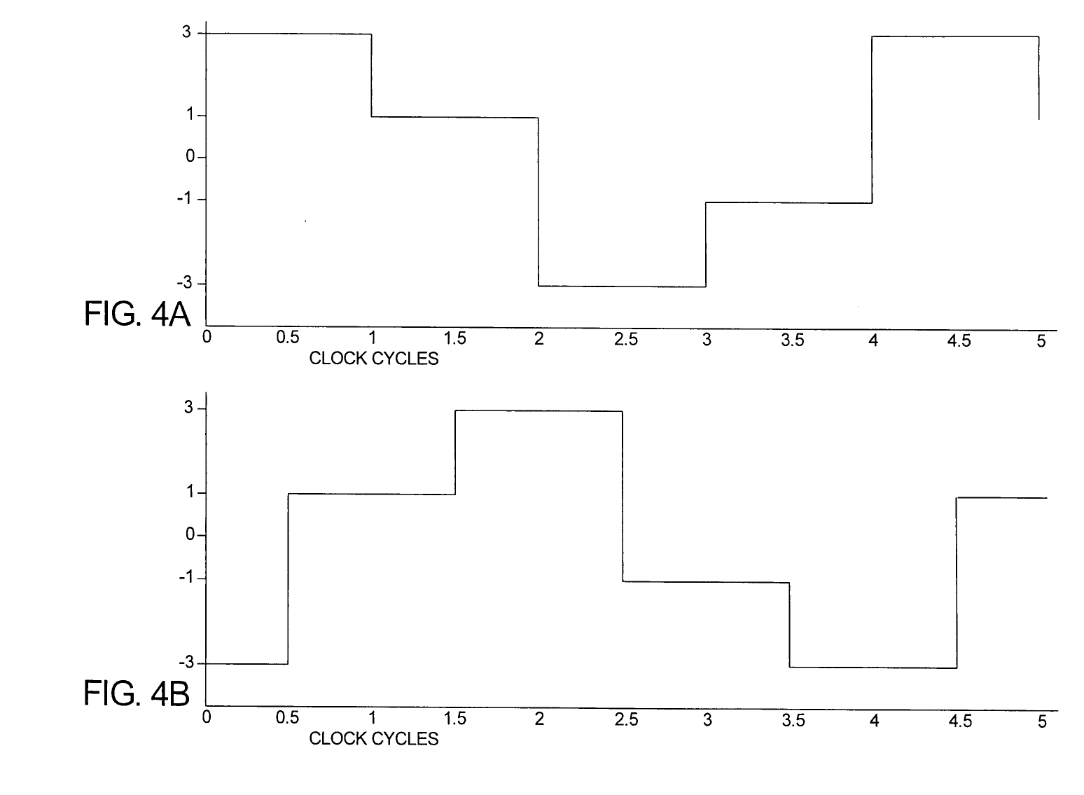

FIGS. 4A and 4B illustrate the waveforms of the output signals of the DAC 88I and 88Q respectively over the first five clock cycles. It will be noted that because the conversion clock of the DAC 88Q is inverted relative to that of the DAC 88I, changes in voltage level of the output signal of the DAC 88Q are delayed by one half cycle relative to changes in voltage level of the output signal of the DAC 88I. Also, since the output of the serializer 82Q is inverted, the output signal of the DAC 88Q is inverted relative to the data values of the set IM. It will be appreciated that instead of providing a hardware inverter at the output of the serializer 82Q, the polarity of the set IM stored in the LUT may be inverted.

The set RE contains exactly 15 repetitions of the sequence (3, 1, −3, −1) and the set IM contains exactly 15 repetitions of the sequence (−1, −3, 1, 3). Accordingly when these sets of values are output from the serializers at a rate of 5280 MHz and are converted to analog form, the lowest frequency component present in the resulting analog signals is at a frequency of 1320 MHz (5280×15/60). The output signals of the DACS 88 are filtered by low-pass Chebyshev filters 90. The output signals of the filters 90 are sinusoidal signals at 1320 MHz and the output signal of the filter 90Q is advanced in phase by π/2 relative to the output signal of the filter 90I. Accordingly, we may designate the output signal of the filter 90I as cos ω_{E}t and the output signal of the filter 90I as −sin ω_{E}t, where ω_{E}/2π=1320 MHz.

The complex baseband signal cos ω_{E}t−j*sin ω_{E}t output by the filters 90 is quadrature modulated by the clock signal, which may be designated cos ω_{C}t+j*sin ω_{C}t, where ω_{C}/2π=5280 MHz. The output signal of the in-phase channel 84I is cos (ω_{E}+ω_{C}) t.

The operation of the quadrature channel 84Q corresponds to that of the in-phase channel 84I, except that the sequence RE is inverted and the connections of the clock signals to the quadrature modulator are reversed. The quadrature channel provides an output signal sin (ω_{E}+ω_{C}) t.

Since ω_{C}/2π=5280 MHz and, in the case of the example discussed above, ω_{E}/2π=1320 MHz and the output signals of the in-phase and quadrature channels are at a frequency of 3960 MHz.

The transmitter also includes a multi-channel subcarrier QPSK modulator 96. The subcarrier modulator comprises N subcarrier oscillators 100₁-100_{N} supplying their output signals cos wit (i=1 . . . N) to respective phase shifters 104. Each phase shifter provides both an in-phase output signal cos (ωᵢt+φᵢ) and a quadrature signal sin (ωᵢt+φᵢ), where φᵢ depends on the data value Di and is 0, π/2, π or 3π/2.

The cosine outputs of the phase shifters 104 are summed and the sine outputs of the phase shifters 104 are summed. A quadrature modulator 108 amplitude modulates the sine and cosine carrier signals, provided by the channels 84I and 84Q respectively, with the composite QPSK sine and cosine signals and supplies a transmission signal to a transmitter antenna 110. This transmission signal is composed of a carrier at 3960 MHz and N subcarriers, each modulated in phase in accordance with a 2-bit data word.

The values stored at the other seven locations in the LUT 80 allow synthesis of cosine and sine signals at frequencies of 3432, 4448, 5016, 5544, 6072, 6600 and 7128 MHz respectively. For example, the sequence shown in Table 3, when read out at 5280 MHz, has a peak at 1848 MHz and when mixed with a signal at 5280 MHz provides a carrier at 3432 MHz. Accordingly, the transmitter synthesizer shown in FIG. 3A is able to generate carriers in bands 1-8 of the WiMedia standard. The bank selector selects each bank of the LUT 80 for an interval of 312.5 ns and then selects the next bank in a cyclically repeating sequence.

TABLE 3

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| RE | 3 | −1 | −1 | 3 | −1 | −1 | 3 | −3 | 1 | 3 | −3 | 1 | 1 | −3 | 1 |
| IM | −3 | −1 | 3 | −3 | 1 | 1 | −3 | 1 | 1 | −3 | 3 | 1 | −3 | 3 | −1 |
| | 15 | 16 | 17 | 18 | 19 | 20 | 21 | 22 | 23 | 24 | 25 | 26 | 27 | 28 | 29 |
| RE | 1 | −3 | 3 | −1 | −3 | 3 | −1 | −1 | 3 | −1 | −1 | 3 | −3 | 1 | 3 |
| IM | −1 | 3 | −1 | −1 | 3 | −3 | −1 | 3 | −3 | 1 | 1 | −3 | 1 | 1 | −3 |
| | 30 | 31 | 32 | 33 | 34 | 35 | 36 | 37 | 38 | 39 | 40 | 41 | 42 | 43 | 44 |
| RE | −3 | 1 | 1 | −3 | 1 | 1 | −3 | 3 | −1 | −3 | 3 | −1 | −1 | 3 | −1 |
| IM | 3 | 1 | −3 | 3 | −1 | −1 | 3 | −1 | −1 | 3 | −3 | −1 | 3 | −3 | 1 |
| | 45 | 46 | 47 | 48 | 49 | 50 | 51 | 52 | 53 | 54 | 55 | 56 | 57 | 58 | 59 |
| RE | −1 | 3 | −3 | 1 | 3 | −3 | 1 | 1 | −3 | 1 | 1 | −3 | 3 | −1 | −3 |
| IM | 1 | −3 | 1 | 1 | −3 | 3 | 1 | −3 | 3 | −1 | −1 | 3 | −1 | −1 | 3 |

The receiver shown in FIG. 3B includes a receiver synthesizer 120 that is substantially similar to the transmitter synthesizer. In FIG. 3B, the reference numeral 2XX, where XX represents two numeric digits, designates a component having a function similar to that of the component designated in FIG. 3A by the numeral XX.

The synthesizer 120 generates a frequency conversion signal having a component cos (ω_{E}+ω_{C}) t at the output of the in-phase channel 284I and a component sin (ω_{E}+ω_{C}) t at the output of the quadrature channel 284Q, where ω_{C}/2π=5280 MHz and ω_{E}/2π steps cyclically and repeatedly through the same values as in FIG. 3A at intervals of 312.5 ns.

A synchronizer 124 receives the receiver antenna signal and adjusts the bank selector of the receiver synthesizer 120 to synchronize the synthesizer 120 with the transmitter synthesizer. The in-phase and quadrature output signals of the receiver synthesizer are mixed with the antenna signal by mixers 126I, 126Q to down-convert the antenna signal to the subcarrier frequency range. It will be appreciated that in a practical implementation, it may be necessary to alter independently the gain and offset of the output signals of the multipliers 126I, 126Q. The receiver has N demodulation channels, responsive to local subcarrier oscillators 130 having the same operating frequencies as the oscillators 100 of the transmitter, for demodulating the down-converted signal and recovering the data words D1 . . . DN.

The quaternary values stored in the LUT 80 are selected based on the magnitudes of prototype cosine and sine functions at phase displacement values that depend on the frequency of the function to be synthesized. It will be appreciated that with only four available data values, the data value cannot be equal to the magnitude of the prototype cosine or sine function at each of the selected phase displacement values. Accordingly, quantization noise (corresponding to the difference between the function value and the data value) is present in the output signal of the DACs. The digital data values are dithered in order to reduce average quantization error and randomize the quantization noise. Thus, for example, in the case of the 1320 MHz signal the set RE would ideally contain repetitions of the sequence (3, 0, −3, 0) and since 0 is not an available data value, this sequence is dithered by mapping alternate values of 0 to +1 and −1). This allows sufficient spectral purity to be obtained to comply with the WiMedia standards. In fact, the transmitter described with reference to FIG. 3A can achieve an ACPR of 29 dB. It is possible to increase the ACPR to at least 30 dB by noise shaping.

The WiMedia standard specifies bands at higher frequencies than band 8, and the higher frequencies can be synthesized by multiplying the frequency of the clock signal provided to the quadrature modulators 92I, 92Q. For example, referring to the multiplier illustrated in dashed line in FIG. 3A, a signal at 7920 MHz can be generated by multiplying the 5280 MHz clock signal by 1.5, and mixing this 7920 MHz signal with the 1320 MHz signal described above produces a 9240 MHz carrier for WiMedia band 12. In addition, it will be appreciated that by inverting the input signals of the quadrature arms 86Q, the output signals of the in-phase and quadrature channels vary as the sum of the frequencies rather than the difference, and this allows, for example, the carrier for band 7 to be synthesized using the same sets of data words as the carrier for band 2.

Because the carrier synthesizer generates the carrier by converting the sequences of digital values to analog form and reconstructing the analog signal, rather than using an oscillator or other resonant circuit, the synthesizer is able to change frequency rapidly and after a change, any frequency components at the previous frequency decay rapidly to a very low level.

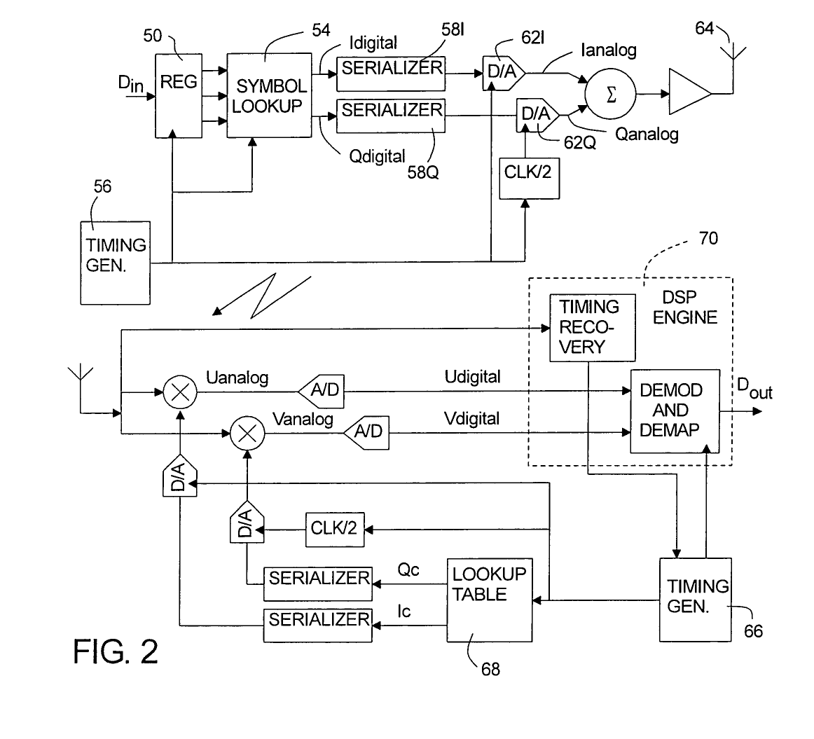

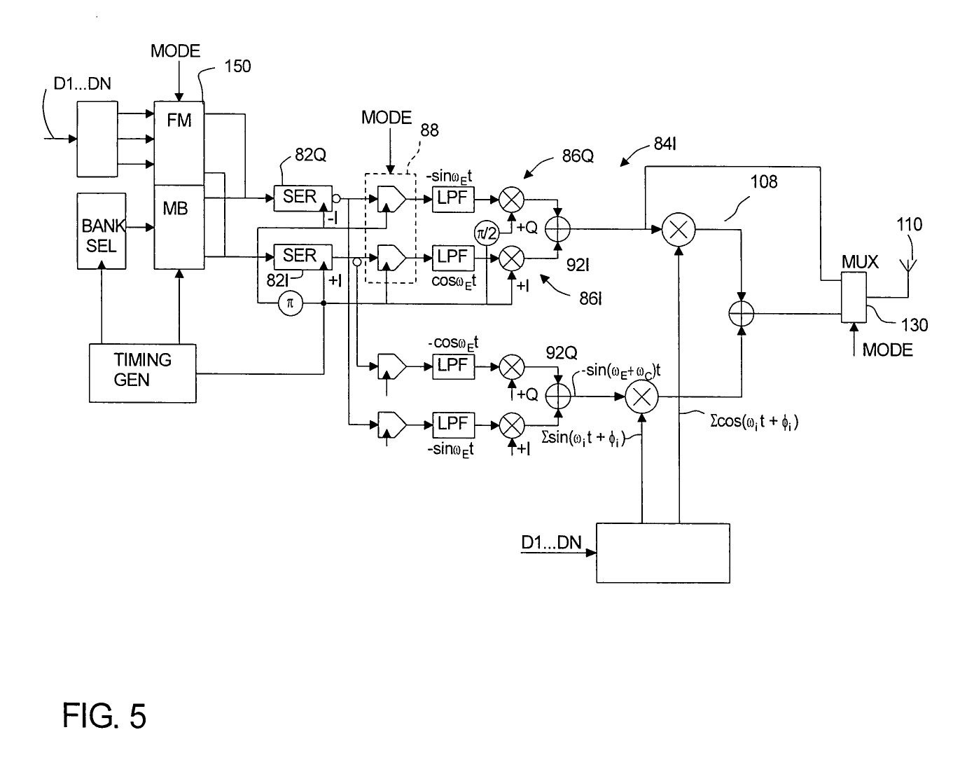

Referring to FIG. 5, the second transmitter embodying the invention is operable selectively either in a multiband mode, as described with reference to FIGS. 3A and 3B, or in an FM mode similar to that described in connection with FIG. 2.

The LUT 150 has two pages that are separately selected depending on the state of a signal MODE and are referred to for convenience as MB and FM. The two pages may be provided by different address ranges in the same monolithic integrated circuit chip or they may be provided by different monolithic chips that are selected in response to a chip select signal. In similar fashion to FIG. 2, the FM page of the lookup table contains, at each location, an array of digital values that represent a sample of a waveform at a given frequency and modulated in phase in accordance with a given symbol. The number of locations in the FM page of the lookup table is such that the FM page stores, for each frequency, waveform samples for each of eight possible values of phase displacement. By appropriately addressing the FM page of the lookup table, reading out the contents of the addressed location of the page, and converting the digital values to analog form, a carrier that varies cyclically in frequency and is modulated in phase is generated.

The MB page has eight banks, each of which stores two sets of 60 2-bit words, as described with reference to FIG. 3A.

The signal MODE also determines the state of a multiplexer 130 and the mapping functions of the DACS 88.

In the MB mode, the signal MODE selects the MB page, selects Table 1 as the mapping function of the DACS, and sets the multiplexer 130 to select the output of the quadrature modulator 108. In this case, the mode of operation of the transmitter is as described with reference to FIG. 3A. In the FM mode, the signal MODE selects the FM page, selects Table 4 as the mapping function of the DACs, and sets the multiplexer 130 to select the output of the quadrature modulator 92I.

TABLE 4

| Input | Output * 3 |
|---|---|
| 0 0 | 0 |
| 0 1 | −3 |
| 1 0 | +3 |
| 1 1 | 0 |

In the FM mode, the sequence of digital values provided by the serializers is encoded with the data and the multiplexer 130 selects the output signal of the in-phase channel 84I as the FM transmission signal.

It will be appreciated that in the FM mode, the output signals of the serializers are not merely converted to analog form and summed, as in the case of FIG. 2, but are also translated in frequency by the quadrature modulator 92I. This frequency translation must be taken into account in selecting the values to be stored in the LUT.

In the case of the transmitter and receiver described with reference to FIG. 2, the sample conversion clock signal has a frequency of 3.2 GHz and the carrier has a range from 3.2 GHz to 6.4 GHz. When the transmitter shown in FIG. 5 is operated in the FM mode, it may be desirable to use a different conversion frequency for the DACs 88, and the carrier frequency range may be different. For example, if a conversion frequency of 5.28 GHz were used, it may be desirable to use a carrier frequency range of 2.64 GHz to 7.92 GHz.

The transmission signal is encoded to indicate whether the transmitter is operating in the multiband mode or the FM mode, for example by including an additional waveform segment at a frequency that is not used for conveying input data. The receiver is similar to the receiver shown in FIG. 3B but the synchronizer distinguishes between the FM mode and the MB mode based on the additional waveform segment and operates the receiver synthesizer accordingly.

By using an LUT to synthesize the subcarrier segments in the MB mode, sharing of components between the two modes of operation is increased relative to previous approaches.

The values stored in the FM page of the LUT may be selected so that the waveform sample is of constant frequency, as mentioned above, or is swept in frequency as described in the copending application.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. An OFDM transmitter comprising:
a lookup means (LUT plus serializers) for storing at least two groups of data digits associated with different respective characteristic frequencies (e.g. 3960 MHz, 5016 MHz),
an addressing means (bank select plus timing gen) for addressing the lookup means and repeatedly and sequentially selecting the two groups of data digits, the lookup means being responsive to the addressing means by outputting sequentially the data digits of the selected group,
a converter means (DACs plus quadrature modulator) for converting a sequence of data digits output by the lookup means to analog form, each group of data digits, when output and converted to analog form, providing a carrier signal at the characteristic frequency associated with that group, and
a modulator means (modulator 108) for modulating the carrier signal in accordance with an information signal to provide a transmission signal.

2. A transmitter according to claim 1, further comprising a generator means for generating a signal at a predetermined frequency (5280 MHz or 7290 MHz, for example) and wherein the converter means comprises an analog-to-digital converter for converting a sequence of data digits output by the lookup means to analog form and providing an analog signal at a difference frequency (1320 MHz) and a means for combining the signal at the difference frequency with the signal at the predetermined frequency to produce the carrier signal at the characteristic frequency associated with the group (3960 MHz or 6600 MHz).

3. A transmitter according to claim 2, wherein the analog-to-digital converter is responsive to the signal at the predetermined frequency for converting the sequence of data digits output by the lookup means to analog form and providing the analog signal at the difference frequency.

4. A transmitter according to claim 1, further comprising a generator means for generating a signal at a conversion frequency (5280 MHz) and wherein the converter means comprises an analog-to-digital converter responsive to the signal at the conversion frequency for converting a sequence of data digits output by the lookup means to analog form and providing an analog signal at a difference frequency (1320 MHz), a multiplier for multiplying the signal at the conversion frequency by a predetermined factor (1.5) to provide a signal at a frequency (7290 MHz) higher than the conversion frequency, and a means for combining the signal at the difference frequency with the signal at the higher frequency to produce the carrier signal at the characteristic frequency associated with the group (6600 MHz).

5. A transmitter according to claim 1, wherein each group of data digits is composed of two sets of data digits, the lookup means is responsive to the addressing means by outputting sequentially the data digits of the two sets of data digits of a selected group, the converter means converts each sequence of data digits output by the lookup means to analog form, and the analog signals generated by converting the two sets of data digits include respective frequency components that are in quadrature and are at a difference frequency that depends on the characteristic frequency.

6. A transmitter according to claim 5, wherein the converter means includes a quadrature modulator for mixing the analog signals with a signal at a conversion frequency and generating an output signal that varies as a sum or difference of the difference frequency and the conversion frequency.

7. A transmitter according to claim 1, comprising a second modulator means for modulating a plurality of subcarriers in accordance with respective elements of a data sequence and combining the modulated subcarriers to provide the information signal.

8. A transmitter according to claim 1, wherein the information signal has an in-phase component and a quadrature component, and the first modulator means is a quadrature modulator that combines the in-phase and quadrature components of the information signal with in-phase and quadrature components respectively of the carrier signal to provide the transmission signal.

9. A transmitter according to claim 1, wherein the lookup means stores at least eight groups of data digits and the addressing means repeatedly and sequentially selects the eight groups of data digits.

10. A transmitter according to claim 1, wherein the lookup means stores at least three groups of data digits and the addressing means repeatedly and sequentially selects the three groups of digits.

11. A transmitter according to claim 1, wherein each group of data digits has a plurality of members, and each member of the group comprises two digits.

12. An OFDM transmitter comprising:
a lookup means (LUT plus serializers) having a first page for storing at least two groups of data digits associated with different respective characteristic frequencies (e.g. 3960 MHz, 5016 MHz) and a second page for storing additional groups of data digits representing respective symbols each characterized by at least one of phase and frequency,
an addressing means (bank select plus timing generator) for addressing the lookup means, the addressing means being operable in a first mode in which the addressing means addresses the first page of the lookup means by repeatedly and sequentially selecting the groups of data digits of the first page, the lookup means being responsive to the addressing means in the first mode by outputting sequentially the data digits of the selected group, and the addressing means being operable in a second mode in which the addressing means addresses the second page of the lookup means in accordance with a group of digital data digits for selecting a symbol, the lookup means being responsive to the addressing means in the second mode by outputting sequentially the data digits representing the selected symbol,
a converter means (DACs plus quadrature modulator 92I) for converting a sequence of data digits output by the lookup means to analog form,
an output means (modulator 108 plus multiplexer 130) having a first state in which the output means receives an output signal of the converter means and modulates said output signal in accordance with an information signal to provide an output signal of the transmitter and having a second state in which the output means provides an output signal of the converter means as an output signal of the transmitter,
and wherein in the event that the addressing means operates in the first mode and the output means is in the first state, the output means provides a transmission signal that is modulated in accordance with said information signal, and in the event that the addressing means operates in the second mode and the output means is in the second state, the output means provides a transmission signal representing said selected symbol.

13. A transmitter according to claim 12, wherein each group of data digits stored in the first page of the lookup means is composed of two sets of data digits, the lookup means is responsive to the addressing means in the first mode by outputting sequentially the data digits of the two sets of data digits of a selected group, the converter means converts each sequence of data digits output by the lookup means to analog form, and the analog signals generated by converting the two sets of data digits include respective frequency components that are in quadrature and are at a difference frequency that depends on the characteristic frequency.

14. A transmitter according to claim 13, wherein the converter means includes a quadrature modulator for mixing the analog signals with a signal at a conversion frequency and generating an output signal that varies as a sum or difference of the difference frequency and the conversion frequency.

15. A transmitter according to claim 12, wherein the converter means comprises an in-phase channel and a quadrature channel, the lookup means is responsive to the addressing means in the first mode by outputting the data digits of the selected group to both the in-phase channel and the quadrature channel, the converter means converts the sequences of data digits output by the lookup means to a signal having an in-phase component and a quadrature component, and the output means comprises a quadrature modulator for modulating the signal provided by the converter means in accordance with an information signal having an in-phase component and a quadrature component.

16. A transmitter according to claim 15, wherein the lookup means is responsive to the addressing means in the second mode by outputting the data digits representing the selected symbol to at least one channel of the converter means, the output means comprises a multiplexer, in the first state of the output means the multiplexer selects the output of the quadrature modulator, and in the second state of the output means the multiplexer selects the output of said one channel of the converter means.

17. An OFDM receiver for receiving a carrier signal modulated in accordance with an information signal, the receiver comprising:
a lookup means (LUT plus serializers) for storing at least two groups of data digits associated with different respective characteristic frequencies (e.g. 3960 MHz, 5016 MHz),
an addressing means (bank select plus timing gen) for addressing the lookup means and repeatedly and sequentially selecting the two groups of data digits, the lookup means being responsive to the addressing means by outputting sequentially the data digits of the selected group,
a converter means (DACs plus quadrature modulator) for converting a sequence of data digits output by the lookup means to analog form, each group of data digits, when output and converted to analog form, providing a frequency conversion signal at the characteristic frequency associated with that group, and
a modulator means (demodulator 108) for modulating the carrier signal in accordance with the frequency conversion signal to provide a baseband information signal for demodulation.

18. A receiver according to claim 17, further comprising a generator means for generating a signal at a predetermined frequency (5280 MHz or 7290 MHz, for example) and wherein the converter means comprises an analog-to-digital converter for converting a sequence of data digits output by the lookup means to analog form and providing an analog signal at a difference frequency (1320 MHz) and a means for combining the signal at the difference frequency with the signal at the predetermined frequency to produce the frequency conversion signal at the characteristic frequency associated with the group (3960 MHz or 6600 MHz).

19. A receiver according to claim 18, wherein the analog-to-digital converter is responsive to the signal at the predetermined frequency for converting the sequence of data digits output by the lookup means to analog form and providing the analog signal at the difference frequency.

20. A receiver according to claim 17, further comprising a generator means for generating a signal at a conversion frequency (5280 MHz) and wherein the converter means comprises an analog-to-digital converter responsive to the signal at the conversion frequency for converting a sequence of data digits output by the lookup means to analog form and providing an analog signal at a difference frequency (1320 MHz), a multiplier for multiplying the signal at the conversion frequency by a predetermined factor (1.5) to provide a signal at a frequency (7290 MHz) higher than the conversion frequency, and a means for combining the signal at the difference frequency with the signal at the higher frequency to produce the frequency conversion signal at the characteristic frequency associated with the group (6600 MHz).

21. A receiver according to claim 17, wherein each group of data digits is composed of two sets of data digits, the lookup means is responsive to the addressing means by outputting sequentially the data digits of the two sets of data digits of a selected group, the converter means converts each sequence of data digits output by the lookup means to analog form, and the analog signals generated by converting the two sets of data digits include respective frequency components that are in quadrature and are at a difference frequency that depends on the characteristic frequency.

22. A receiver according to claim 21, wherein the converter means includes a quadrature modulator for mixing the analog signals with a signal at a conversion frequency and generating an output signal that varies as a sum or difference of the difference frequency and the conversion frequency.

23. A receiver according to claim 17, comprising a second demodulator means for receiving a plurality of demodulation signals and demodulating the baseband information signal to recover a data sequence therefrom.

24. A receiver according to claim 17, wherein the frequency conversion signal has an in-phase component and a quadrature component, and the first modulator means is a quadrature modulator that combines the in-phase and quadrature components of the frequency conversion signal with the carrier signal to provide in-phase and quadrature components respectively of the baseband information signal.

25. A receiver according to claim 17, wherein the lookup means stores at least eight groups of data digits and the addressing means repeatedly and sequentially selects the eight groups of data digits.

26. A receiver according to claim 17, wherein the lookup means stores at least three groups of data digits and the addressing means repeatedly and sequentially selects the three groups of digits.

27. A receiver according to claim 17, wherein each group of data digits has a plurality of members, and each member of the group comprises two digits.
